(19) United States
(12) Patent Application Publication
(10) Pub. No.: US 2021/0075561 A1
(43) Pub. Date: Mar. 11, 2021

(54) ACKNOWLEDGMENT SIGNALING IN A RADIO ACCESS NETWORK

(71) Applicant: Telefonaktiebolaget LM Ericsson (publ), Stockholmse (SE)

(72) Inventors: Robert BALDEMAIR, Solna (SE); Stefan PARKVALL, Bromma (SE)

(21) Appl. No.: 16/644,351

(22) PCT Filed: Sep. 8, 2017
(86) PCT No.: PCT/SE2017/050890

§ 371 Date: Mar. 4, 2020

(51) Int. Cl. H04L 1/18; H04L 1/16

(52) U.S. Cl. CPC H04L 1/1896; H04L 1/1614

(57) ABSTRACT

There is disclosed a method of operating a user equipment in a radio access network—The method includes transmitting acknowledgement signaling, the acknowledgement signaling representing acknowledgement information having an acknowledgement bit pattern. The acknowledgement bit pattern includes a plurality of subpatterns, each subpattern representing acknowledgment information pertaining to one of a plurality of data block structures, the bit pattern being determined based on a total assignment indication and one or more assignment indications. Each of the one or more assignment indications indicates a bit size of an associated subpattern. Furthermore, the total assignment indication indicates a bit size of the acknowledgement bit pattern. The disclosure also pertains to related devices and methods.

### TECHNICAL FIELD

This disclosure pertains to the field of wireless communication technology, in particular in the context of a radio access network (RAN) like NR.

### BACKGROUND

Acknowledgement signaling processes like HARQ or ARQ are widely used in wireless communication technology (telecommunications) to facilitate low error rates when transferring data. With the introduction of more flexibility into communication systems, handling acknowledgement signaling becomes more complex, in particular with the capability of utilising different reporting types for acknowledgement signaling and increasing number of signaling processes to consider.

### SUMMARY

It is an object of this disclosure to provide approaches allowing efficient signaling in the context of acknowledgement signaling, in particular HARQ processes and/or for a dynamic HARQ codebook.

The approaches are particularly advantageously implemented in a 5^{th} Generation (5G) telecommunication network or 5G radio access technology or network (RAT/RAN), in particular according to 3GPP (3^{rd} Generation Partnership Project, a standardisation organization). A suitable RAN may in particular be a RAN according to NR, for example release 15 or later, or LTE Evolution.

Accordingly, there is disclosed a method of operating a user equipment or (second) radio node in a radio access network. The method comprises transmitting acknowledgement signaling, the acknowledgement signaling representing acknowledgement information having an acknowledgement bit pattern. The acknowledgement bit pattern comprises a plurality of subpatterns, each subpattern representing acknowledgment information pertaining to one of a plurality of data block structures. The bit pattern is being determined based on a total assignment indication and one or more assignment indications. Each of the one or more assignment indications indicates a bit size of an associated subpattern, and the total assignment indication indicates a bit size of the acknowledgement bit pattern.

Moreover, a user equipment or (second) radio node for a radio access network is disclosed. The user equipment or radio node is adapted for transmitting acknowledgement signaling, the acknowledgement signaling representing acknowledgement information having an acknowledgement bit pattern. The acknowledgement bit pattern comprises a plurality of subpatterns, each subpattern representing acknowledgment information pertaining to one of a plurality of data block structures. The bit pattern is determined based on a total assignment indication and one or more assignment indications. Each of the one or more assignment indications indicates a bit size of an associated subpattern, and the total assignment indication indicates a bit size of the acknowledgement bit pattern. The user equipment or radio node may comprise, and/or be adapted for utilising, processing circuitry and/or radio circuitry, in particular a transmitter and/or transceiver and/or receiver, for transmitting the acknowledgement signaling and/or determining the bit pattern and/or receiving the assignment indications. Alternatively, or additionally, it may comprise a corresponding transmitting module and/or determining module and/or receiving module, respectively. A second radio node may be implemented as network node in particular in backhaul communication scenarios.

A method of operating a radio node in a radio access network may be considered. The method comprises configuring a second radio node, e.g. a user equipment, for transmitting acknowledgment signaling, the acknowledgement signaling representing acknowledgement information having an acknowledgement bit pattern. The acknowledgement bit pattern comprises a plurality of subpatterns, each subpattern representing acknowledgment information pertaining to one of a plurality of data block structures. Configuring comprises transmitting, to the second radio node, one or more assignment indications indicating a bit size of an associated subpattern, as well as a total assignment indication indicating a bit size of the acknowledgement bit pattern.

There is also disclosed a radio node for a radio access network. The radio node is adapted for configuring a second radio node, e.g. a user equipment (UE) for transmitting acknowledgment signaling. The acknowledgement signaling represents acknowledgement information having an acknowledgement bit pattern. The acknowledgement bit pattern comprises a plurality of subpatterns, each subpattern representing acknowledgment information pertaining to one of a plurality of data block structures. Configuring comprises transmitting, to the second radio node, one or more assignment indications indicating a bit size of an associated subpattern, as well as a total assignment indication indicating a bit size of the acknowledgement bit pattern. The radio node, which may be referred to as configuring radio node, may comprise, and/or be adapted for utilising, processing circuitry and/or radio circuitry, in particular a transmitter and/or transceiver, for such configuring. Alternatively, or additionally, the radio node may comprise a corresponding configuring module. A (configuring) radio node may in particular be a network node, e.g. a base station. However, in some cases, the radio node may be a UE, e.g. for sidelink communication.

A method of operating a receiving radio node in a radio access network may be considered, and/or a receiving radio node for a radio access network may be considered. The method may comprise, and/or the receiving radio node may be adapted for, receiving acknowledgement signaling, e.g. acknowledgement signaling as described herein. The acknowledgement signaling represents acknowledgement information having an acknowledgement bit pattern. The acknowledgement bit pattern comprises a plurality of subpatterns, each subpattern representing acknowledgment information pertaining to one of a plurality of data block structures. The receiving radio node may comprise, and/or be adapted for utilising, processing circuitry and/or radio circuitry, in particular a receiver and/or transceiver, for such receiving. Alternatively, or additionally, the receiving radio node may comprise a corresponding receiving module. The receiving radio node may be implemented as a network node and/or a configuring radio node. In some variants, the receiving radio node may be implemented as user equipment, e.g. for sidelink communication.

Each data block structure of the plurality of data block structures may correspond to a scheduled data block, e.g. for data signaling. The data blocks may be associated to separately scheduled transmissions, e.g. separate channels and/or instances and/or carriers and/or component carriers and/or data streams, e.g. in the context of carrier aggregation and/or multiple-antenna transmissions, e.g. MIMO (Multiple-Input, Multiple-Output). The data blocks and/or associated data signaling may be for downlink, or in some cases for sidelink. The acknowledgement signaling may generally be uplink signaling, but in some variants may be sidelink signaling. A subpattern may represent the acknowledgement information and/or feedback for the associated data block, e.g. with the size as indicated by the assignment indication. Different data blocks may be associated to different transmission instances and/or different acknowledgment signaling processes, e.g. HARQ processes.

A data block structure may generally represent, and/or be associated to, a scheduled data block and/or corresponding signaling. The data block may be scheduled for reception, e.g. by a control information message. In some cases, a scheduled data block may not be received, which may be reflected in the corresponding acknowledgement signaling. The number of data block structures, and/or the number of assignment indications, may be considered to represent a number of transmissions of data scheduled to be received by the user equipment (or second radio node).

Different assignment indications may be included in different control information messages. A control information message may in particular be transmitted as control signaling, e.g. associated to a control channel like a PDCCH or PSCCH.

An assignment indication may generally indicate the location and/or order of the subpattern in the bit pattern, e.g. relative to one or more other subpatterns. It may be considered that an assignment indication comprises an indicator, which may be represented as a bit pattern comprising a number of N bits, wherein N may be larger than 1, or 2. In some variants, N may be 3 or 4. N may be configurable, e.g. by higher-layer signaling and/or semi-statically, and/or may be dependent on the number of transmissions of data blocks.

An acknowledgement bit pattern may be considered to be determined and/or represented by a codebook, e.g. a HARQ codebook. The codebook may be dynamically determined, e.g. based on the assignment indications and/or total assignment indication. An assignment indication may be implemented as counter and/or corresponding to a downlink assignment indication like a DAI (Downlink Assignment Indication). A total assignment indication may be implemented as a counter and/or corresponding to a total DAI.

Generally, the acknowledgement signaling may be signaling at one instance and/or in one transmission timing structure, and/or scheduled for common transmission and/or the acknowledgement information may be jointly encoded and/or modulated. The acknowledgement information may pertain to a plurality of different transmissions, associated to and/or represented by the data block structures, respectively the associated data blocks or data signaling. The data block structures, and/or the corresponding blocks and/or signaling, may be scheduled for simultaneous transmission, e.g. for the same transmission timing structure, in particular within the same slot or subframe, and/or on the same symbol/s. However, alternatives with scheduling for non-simultaneous transmission may be considered. For example, the acknowledgment information may pertain to data blocks scheduled for different transmission timing structures, e.g. different slots (or mini-slots, or slots and mini-slots) or similar. Scheduling signaling may generally comprise indicating resources, e.g. time and/or frequency resources, for example for receiving or transmitting the scheduled signaling.

A configuring radio node may generally be adapted for scheduling data blocks for transmission and/or to provide and/or determine and/or configure associated assignment indications, which may include the total assignment indication. Configuring a second radio node may comprise such scheduling and/or associated determining and/or configuring and/or providing of the assignment indications.

The assignment indications (as transmitted and/or provided by the configuring network node) may generally be ordered, e.g. according to a structure and/or list and/or numbering. The order may be according to time and/or frequency (of transmission) and/or transmission mode or method and/or priority and/or size and/or acknowledgement signaling process, etc. Ordering may be performed by the (configuring) radio node, e.g. when scheduling the data blocks. Generally, the order may facilitate numbering, and/or a count of, data blocks and/or associated structures and/or subpatterns to which the acknowledgement signaling pertains and/or is scheduled for. In particular, to each assignment indication here may be associated a number. Each assignment indication may in some variants indicate an accumulated bit size, which may represent the sum of the sizes of the subpatterns associated to the assignment indications up to the current assignment indication according to the order. The total assignment indication may indicate the sum of all sizes of subpatterns. The last (according to the order) of the assignment indications may thus may indicate the sum of all sizes of subpatterns as well. Alternatively, or additionally, an assignment indication may, e.g. implicitly or explicitly, indicate the size of a subpattern and/or its location in the pattern, for example the location of a reference bit of the subpattern within the acknowledgement bit pattern, e.g. the first and/or the last bit. The location may be indicated relative to the acknowledgement bit pattern, e.g. as a number of a bit in the acknowledgement bit pattern, and/or relative to one or more subpatterns. It may be considered that the location is indicated in reference to the order. Different subpatterns may have different bit sizes. An assignment indication may comprise one or more values and/or indicators and/or bit fields. In some cases, different indicators may be provided e.g. to indicate size and location. The total assignment indication may comprise an indicator and/or value representing and/or indicating the size of the acknowledgement bit pattern, and/or the total size of the acknowledgment information in bits, and/or the sum of the bit sizes of the subpatterns. The acknowledgement bit pattern may consist of the subpatterns, e.g. according to an order, which may be configured and/or configurable, and/or indicated, e.g. with an order or location indication.

An assignment indication may be transmitted in a control information message (respectively, received in such), which may be considered control signaling, in particular in downlink or sidelink, for example as DCI or SCI. Different assignment indications may be in different control information messages. A control information message may in particular be a scheduling assignment.

Generally, the bit sizes of the one or more subpatterns may be configurable, in particular configurable to be different between at least two subpatterns. The bit sizes may be configured with the assignment indication, and/or with higher layer signaling.

The bit size of at least one of the subpatterns may generally be larger than one. The bit size of a subpattern (and/or the plurality of patterns) may be determined based on the acknowledgement information expected and/or the unit size used for indicating the bit size. The unit size (the number of bits represented by the unit) may be equal to, or larger than the number of bits of the expected acknowledgement information.

It may be considered that the bit sizes of a plurality of subpatterns have a common largest divisor larger than 1. This divisor may represent the unit in which the assignment indications indicate the bit size of the associated subpatterns and/or the total assignment indication indicates the total size. The divisor may be configured to the user equipment and/or second radio node, e.g., with higher layer signaling (e.g., RRC signaling or MAC signaling). In some cases, the divisor may be implicitly indicated, e.g. based on the total assignment indication and/or one or more assignment indications. Configuring the second radio node or user equipment may be based on selecting the bit sizes to have a common largest divisor as described herein, e.g. based the required size of one or more subpatterns, e.g. the largest and/or smallest, and/or the number of bits available for the total assignment indication, and/or the number of bits available for a assignment indication, the latter in particular in relation to the number of bits expected for the associated feedback and/or subpattern.

The plurality of data block structures may comprise, and/or represent, one or more transport blocks and/or one or more code blocks and/or one or more code block groups.

It may be considered that the assignment indication for a subpattern is included in a control information message, which may schedule the data block structure to which the subpattern pertains. Scheduling the data block structure may comprise and/or represent configuring the user equipment or second radio node to receive a corresponding data block, e.g. on scheduled or indicated resources.

The control information message may generally be a scheduling assignment (SA), which may for example be transmitted as DCI or SCI. An indication may generally comprise and/or be represented by an indicator, which may represent an integer value, e.g. counting units as described herein.

Generally, the total assignment indication may be included in a control information message, which may also include an assignment indication for a subpattern. In some variants, the total assignment indication may be included in a plurality of control information messages, each of which may include an assignment indication, in particular a different assignment indication, and/or an assignment indication associated to a different data block structure. It may be considered that each assignment indication is included into a control information message also including the total assignment indication.

In some variants, the total assignment indication and an assignment indication for a subpattern may be included in a control information message also scheduling the data block structure to which the subpattern pertains. Thus, the control information message, which may be a scheduling assignment, may comprise a large amount of information.

The assignment indications may represent accumulated sums of bit sizes of subpatterns. The sums may be determined recursively based on the sum of bit sizes represented by one or more other assignment indications, e.g. according to an order of the assignment indications and/or the associated subpatterns. For example, a first assignment indication may indicate the size of a subpattern associated to it, a second assignment indication may indicate the sum of the size of the subpattern associated to the second assignment indication and the sum represented by the first assignment indication (which has only one component), etc. The sizes of the subpatterns may be indicated with reference to one or more other subpatterns.

Generally, it may be considered that an assignment indication and/or the total assignment indication indicates the bit size in units representing an integer number of bits larger than 1. Each assignment indication may indicate the associated bit size in this way, which may also be valid for the total assignment indication. However, other solutions may be considered. A reference assignment indication and/or associated control information message and/or higher layer may indicate the unit size (number of bits represented by the unit). The unit size may be determined based on the largest common divisor, and/or represent it and/or its value.

A codebook may be considered to associate to acknowledgement signaling an acknowledgement bit pattern, e.g. by defining and/or indicating, the bit pattern to be used for acknowledgment signaling. A bit pattern may be considered to be associated to acknowledgment signaling for example if the acknowledgement information to be signaled with the signaling is provided and/or indicated and/or represented in the bit pattern. A codebook may generally define and/or indicate the size and/or structure of the bit pattern. The structure of a bit pattern may be considered to indicate which bits or subpatterns are arranged where in the pattern, and/or map subpatterns to acknowledgement signaling processes and/or component carriers and/or data block structures. In addition, the codebook may indicate which subpatterns form a group (are grouped together), e.g. based on reporting type, in particular size.

The size of a bit pattern or subpattern may indicate the number of bits in the bit pattern or subpattern. Generally, a subpattern may be considered a part of the bit pattern, representing a (smaller) pattern of bits and/or a part of the bit pattern.

A data block structure may generally represent, and/or correspond to, a data block, which may generally be a block of data and/or bits. A data block may for example be a transport block, code block, or code block group. It may be considered that a data block structure represents a data block which may be intended to be subjected to an acknowledgement signaling process. A data block may comprise one or more subblocks, which may be grouped into one or more subblock groups, e.g. code block groups. A data block may in particular be a transport block, which may comprise one or more code blocks and/or one or more code block groups. A data block structure may be considered to accordingly represent a transport block, code block or code block group. A subblock group like a code block group may comprise one or more subblocks, e.g. code blocks. It may be considered that a data block comprises one or more subblock groups, which may have the same or different sizes (e.g., in number of bits, e.g. systemic and/or coding bits). It may be considered that a data block comprises systemic bits (which may be considered to represent data to be transmitted) and/or coding bits, e.g. bits for error coding like error detection and/or error correction coding, and/or parity or CRC (Cyclic Redundancy Check) bits. A subblock (e.g., code block) and/or subblock group (e.g., code block group) may analogously comprise systemic and/or coding bits.

An acknowledgment signaling process may be a HARQ process, and/or be identified by a process identifier, e.g. a HARQ process identifier or subidentifier. A codebook may in particular be a HARQ codebook. Acknowledgement signaling and/or associated acknowledgement information may be referred to as feedback. It should be noted that data blocks or structures to which subpatterns may pertain may be intended to carry data (e.g., systemic and/or coding bits). However, depending on transmission conditions, such data may be received or not received (or not received correctly), which may be indicated correspondingly in the feedback. In some cases, a subpattern may comprise padding bits, e.g. if the acknowledgement information for a data block requires fewer bits than indicated as size of the subpattern. Such may for example happen if the size is indicated by a unit size larger than required for the feedback.

Acknowledgment information may generally indicate at least ACK or NACK, e.g. pertaining to an acknowledgment signaling process, or an element of a data block structure like a data block, subblock group or subblock. Generally, to an acknowledgment signaling process there may be associated one specific subpattern and/or a data block structure, for which acknowledgment information may be provided.

An acknowledgment signaling process may determine correct or incorrect reception, and/or corresponding acknowledgement information, of a data block like a transport block based on coding bits associated to the data block, and/or based on coding bits associated to one or more data block and/or subblocks and/or subblock group/s. Acknowledgement information (determined by an acknowledgement signaling process) may pertain to the data block as a whole, and/or to one or more subblocks or subblock groups. A code block may be considered an example of a subblock, whereas a code block group may be considered an example of a subblock group. Accordingly, the associated subpattern may comprise one or more bits indicating reception status or feedback of the data block, and/or one or more bits indicating reception status or feedback of one or more subblocks or subblock groups. Each bit of the subpattern may be associated and/or mapped to a specific data block or subblock or subblock group. In some variants, correct reception for a data block may be indicated if all subblocks or subblock groups are correctly identified. In such a case, the subpattern may represent acknowledgement information for the data block as a whole, reducing overhead in comparison to provide acknowledgement information for the subblocks or subblock groups. The smallest structure (e.g. subblock/subblock group/data block) the subpattern provides acknowledgement information for and/or is associated to may be considered its (highest) resolution. In some variants, a subpattern may provide acknowledgment information regarding several elements of a data block structure and/or at different resolution, e.g. to allow more specific error detection. For example, even if a subpattern indicates acknowledgment signaling pertaining to a data block as a whole, in some variants higher resolution (e.g., subblock or subblock group resolution) may be provided by the subpattern. A subpattern may generally comprise one or more bits indicating ACK/NACK for a data block, and/or one or more bits for indicating ACK/NACK for a subblock or subblock group, or for more than one subblock or subblock group.

A subpattern may pertain to one acknowledgement signaling process and/or one component carrier and/or data block structure or data block. It may in particular be considered that one (e.g. specific and/or single) subpattern pertains, e.g. is mapped by the codebook, to one (e.g., specific and/or single) acknowledgement signaling process, e.g. a specific and/or single HARQ process. It may be considered that in the bit pattern, subpatterns are mapped to acknowledgement signaling processes and/or data blocks or data block structures on a one-to-one basis. In some variants, there may be multiple subpatterns (and/or associated acknowledgment signaling processes) associated to the same component carrier, e.g. if multiple data streams transmitted on the carrier are subject to acknowledgement signaling processes. A subpattern may comprise one or more bits, the number of which may be considered to represent its size or bit size. Different bit n-tupels (n being 1 or larger) of a subpattern may be associated to different elements of a data block structure (e.g., data block or subblock or subblock group), and/or represent different resolutions. There may be considered variants in which only one resolution is represented by a bit pattern, e.g. a data block. A bit n-tupel may represent acknowledgement information (also referred to a feedback), in particular ACK or NACK, and optionally, (if n>1), may represent DTX/DRX or other reception states. ACK/NACK may be represented by one bit, or by more than one bit, e.g. to improve disambiguity of bit sequences representing ACK or NACK, and/or to improve transmission reliability.

Configuring a codebook, and/or the bit pattern, may comprise transmitting one or more scheduling assignments, each of which may configure feedback (acknowledgment information), which may be scheduled in response to a scheduled data transmission, e.g. of one or more data blocks. The scheduling assignment may schedule/configure for the UE the feedback and/or the scheduled data transmission. A scheduling assignment may alternatively or additionally indicate a total number of subpatterns to be included in the codebook, or a corresponding total number of bits for such subpatterns. Such a total number may for example be represented by a total DAI (Downlink Assignment Indicator), which may be included in each scheduling assignment transmitted. A total DAI may be provided in each scheduling assignment, wherein the total DAI may pertain to one transmission of acknowledgement signaling and/or a specific transmission timing structure for which the feedback is scheduled.

An order of subpatterns and/or assignment indications as described herein may be configured or configurable to the UE or second radio node, and/or may be predefined.

It should be noted that acknowledgement information may be encoded and/or modulated and/or mapped to symbols for transmission as acknowledgement signaling, respectively that such signaling may be decoded and/or demodulated to retrieve the acknowledgment information. Transmitting and/or receiving may comprise such en- or decoding and/or modulating or demodulating.

There is also disclosed a program product comprising instructions causing processing circuitry to control and/or perform any one of the methods described herein.

Moreover, a carrier medium arrangement carrying and/or storing a program product as disclosed herein may be considered.

The approaches described herein allow efficient control of acknowledgement signaling, with low overhead, while facilitating flexible or dynamic control. This is particular advantageous in the context of large sizes of acknowledgement information, e.g. for carrier aggregation, and/or for scenarios with different sizes for subpatterns. The approaches allow in particular to determine the size of subpatterns, e.g. based on accumulated sizes and/or in relation to a total size, and/or the location of a subpattern even if one or more assignment indications transmitted are not received, e.g. due to a scheduling assignment being lost. Indicating the size in units as described herein facilitates particularly efficient signaling in the context of differently sized subpatterns. Specifically, downlink control signaling overhead may be limited, which is particularly important for efficiency in a RAN.

### BRIEF DESCRIPTION OF THE DRAWINGS

The drawings are provided to illustrate concepts and approaches described herein, and are not intended to limit their scope. The drawings comprise:

FIG. 1, showing an exemplary scheme of indicating a HARQ codebook;

FIG. 2, showing another exemplary scheme of indicating a HARQ codebook;

FIG. 3, showing another exemplary scheme of indicating a HARQ codebook;

FIG. 4, showing another exemplary scheme of indicating a HARQ codebook;

FIG. 5, showing another exemplary scheme of indicating a HARQ codebook;

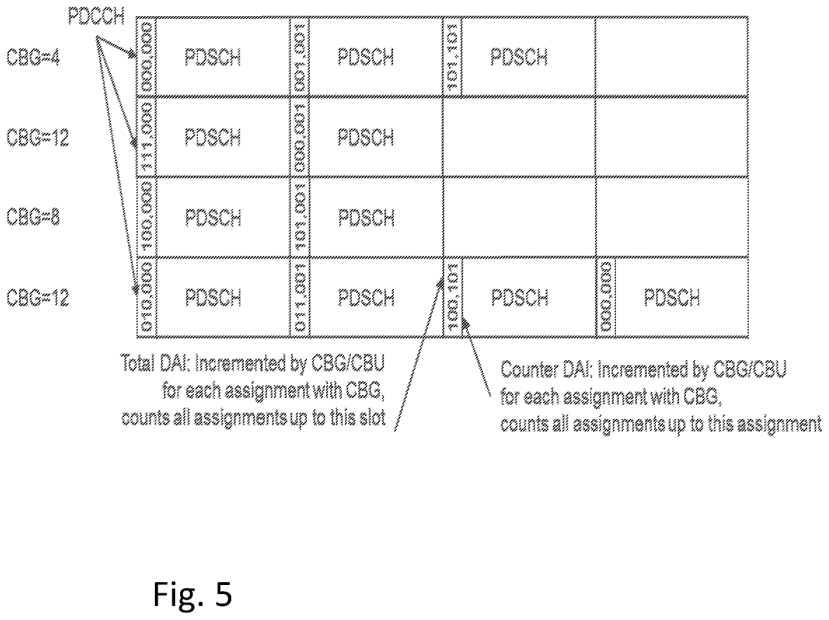

FIG. 6, showing an exemplary HARQ codebook;

FIG. 7, showing an exemplary radio node implemented as user equipment; and

FIG. 8, showing an exemplary radio node implemented as network node like a base station or eNB or gNB.

### DETAILED DESCRIPTION

In the following, detailed variants are described in a specific example for NR. However, other contexts may be considered. In particular, the bit size of subpatterns may be determined based on other parameters, e.g. based on reliability requirements (e.g., BLER), in addition to, or alternatively, to the transport block segmentation.

Generally, a transport block may be segmented into multiple code blocks if the transport block exceeds a certain size. For error detection, each code block as well as the transport block may have its own CRC/coding bits. For NR, HARQ feedback may be provided for transport blocks, or for code block groups (CBG). In this case, one or multiple code blocks may be grouped into a CBG, and one HARQ feedback bit is generated for each CBG (variants with more than one bit for each CBG may be considered). Accordingly, only a fraction of the transport blocks may be required to be retransmitted if only one or few CBG are in error. It should be noted that different data blocks or transport blocks may be segmented differently, such that for example different CBG sizes may apply for different data block structures.

A UE configured with both carrier aggregation and CBG-based HARQ feedback can have largely varying UCI sizes, depending on number of configured/activated component carriers and CBG configurations. If different CBG configurations exist across component carriers, it is not enough to know that one or two DL assignments (scheduling assignments) have been missed, one also needs to know the size of the expected associated acknowledgement signaling, e.g. corresponding HARQ feedback and/or the subpattern. Without this knowledge, the HARQ codebook size as well as the internal bitmap ordering of the acknowledgement but pattern may be wrong.

There may be considered approaches in which the number of CBG configurations across component carriers is chosen/constructed so that all CBG sizes have a largest common divisor preferable larger than 1, e.g. the configured maximum number of CBG across the carriers could be 8, 12, and 16 (the largest common divisor in this example would be 4). A mechanism employing assignment indications and a total assignment indication may be used, e.g. corresponding to a DAI (like a counter DAI) and a total DAI. The total DAI and/or the counter DAI may indicate the total size of the HARQ feedback up to and including the current slot/current assignment; the total DAI may represent the last assignment or the total size. To reduce the field size of the total DAI (and optionally of the counter DAI if the counter DAI counts sizes), the DAI may count in units of the largest common divisor, in above example this unit would be 4. The proposed solution enables the usage of a dynamic (both in component carrier and time dimension) HARQ codebook for carrier aggregation together with CBG configuration. Compared to a fixed HARQ codebook, the HARQ codebook size and thus UL overhead is reduced.

Also, compared to forcing the same CBG configuration on all component carrier the HARQ codebook size and thus UL overhead is reduced.

In the following, a control information message may be indicated as PDSCH transmission, in particular in the Figures. A counter DAI may be considered an example of an assignment indication, a total DAI an example of a total assignment indication. A CBU may be considered an example of a unit in which subpatterns and/or the bit size/s are indicated.

The CBG configurations (e.g., configured maximum number of CBG for a carrier) for the aggregated component carriers are denoted CBGᵢ with i the component carrier index. A Common CBG BU) is now defined as CBU=LCD(CBG₁, CBG2, . . . ) the largest common divisor (LCD) of the configured maximum CBG sizes across the aggregated carriers. The aggregated carriers can either refer to activated or configured component carriers. Using the CBU, the CBG size for component carrier i can be expressed as CBGᵢ=kᵢCBU. The values ki may be considered representative of assignment indications, and/or be indicated in scheduling assignments.

Each DL or scheduling assignment (typically contained in a DCI) contains a counter DAI and a total DAI. The total DAI should be a measure of the size of the total HARQ codebook (e.g., it should reflect the size of all HARQ acknowledgements contained in the HARQ codebook starting from the first DL transmission up to now including all DL transmissions of the current slot). If an DL assignment is scheduled on component carrier (which has a CBG size CBGᵢ=kᵢCBU), the UE needs to insert a bitmap of size CBGᵢ into the HARQ codebook; the total DAI should thus be increased by CBGᵢ. However, since all CBG values have the common LCD CBU, the total DAI has not to be increased by CBGᵢ, but only kᵢ without creating ambiguities. Since kᵢ is smaller than CBGᵢ (at least if CBU>1) the total DAI grows slower, facilitating more efficient signaling.

Typically, the total DAI is not included as is, but a modulo-operation is applied to it to reduce its value range enabling fewer bits to encode it. As an example, a function b=mod(n−1,L) may map the range of natural numbers (and the number of assignments is one or more, thus can be expressed as a natural number) to the value range [symbol] . . . L−1, which can be encoded with [ld( [symbol] )] bit, e.g. with [symbol] =8 3 bit are needed to encode the total DAI. As the total DAI is not incremented by 1 for each DL assignment, but by CBU, which can rather quickly lead to a wrap around and ambiguities, especially if the mod-operation is not (sufficiently) larger than CBU or the UE misses some DL assignments. The total DAI should thus be encoded with a sufficiently large number of bits, e.g. more than 2 bit, in particular 3, 4 or 5 bits. The field size (alternatively the mod-operation) can either be configured or predefined, e.g. hard coded in the spec, and/or determined by a rule depending (among others) on CBU. A small CBU together with a large configured maximum number of CBG on at least one component carrier typically favors larger bitfield sizes to avoid early wrap-around effects of the total DAI. If configured, the network node or gNB would probably take the CBU size into account when determining the configuration, a hybrid solution would be a rule where the network node or gNB configures one or more parameters in the rule.

The counter DAI can be increased by 1 for each DL assignment or in units of CBU, e.g. similar to the total DAI. Increasing the counter DAI in steps of 1 saves DL overhead, since a smaller field size is sufficient. Increasing the counter DAI in units of CBU catches more error cases but requires a larger DL overhead due to the larger required field size (the same considerations on the bitfield size as for the total DAI apply).

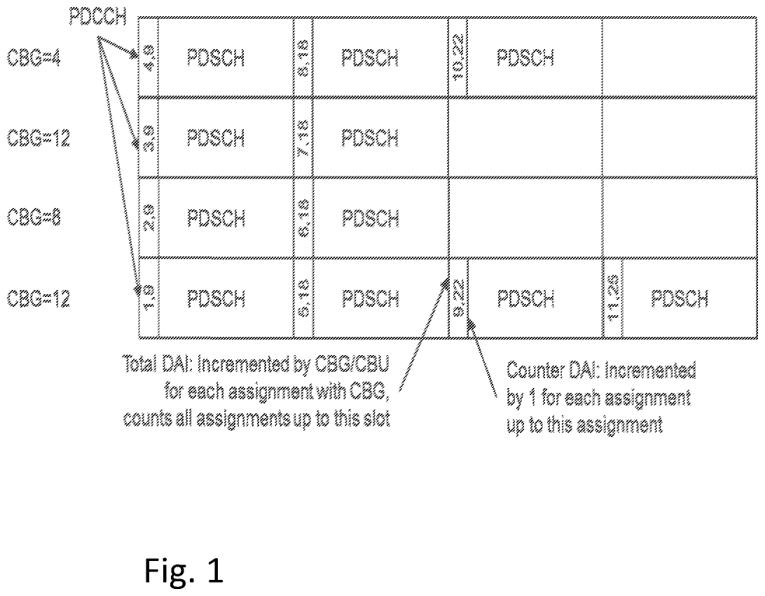

FIG. 1 shows an example with 4 component carriers and configured CBG values of 4, 8, and 12. The CBU size in this configuration is CBU=LCD(4,8,12)=4. The counter DAI is increased in steps of 1. No modulo operation is applied to counter and total DAI.

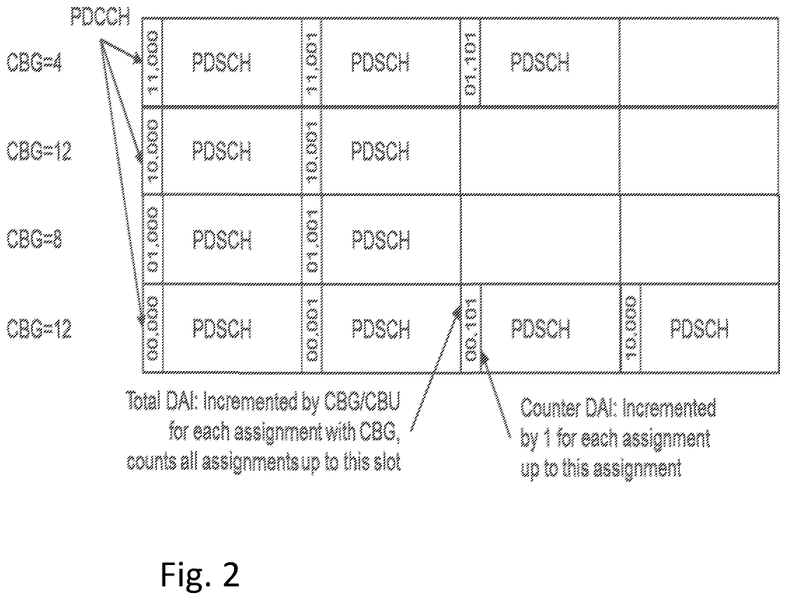

Error! Reference source not found. FIG. 2 shows an example similar to FIG. 1, but modulo operations are applied to the DAI fields. Total and counter DAI are expressed and encoded as DAI_{tot,mod}−mod(DAIₜₒₜ−1, 8) and DAI_{count,mod}=mod(DAI_{count},4) using 3 and 2 bit, respectively (DAIₓₓₓ and DAI_{xxx,mod} are the DAI counters prior modulo operation (as in FIG. 1) and after modulo-operation (as in FIG. 2), respectively). Specifically, FIG. 2 shows an illustration of a DAI mechanism where the total DAI is increased by CBU. In this configuration CBU=4. Total DAI and counter DAI are transformed using modulo-8 and modulo-4 operations, respectively.

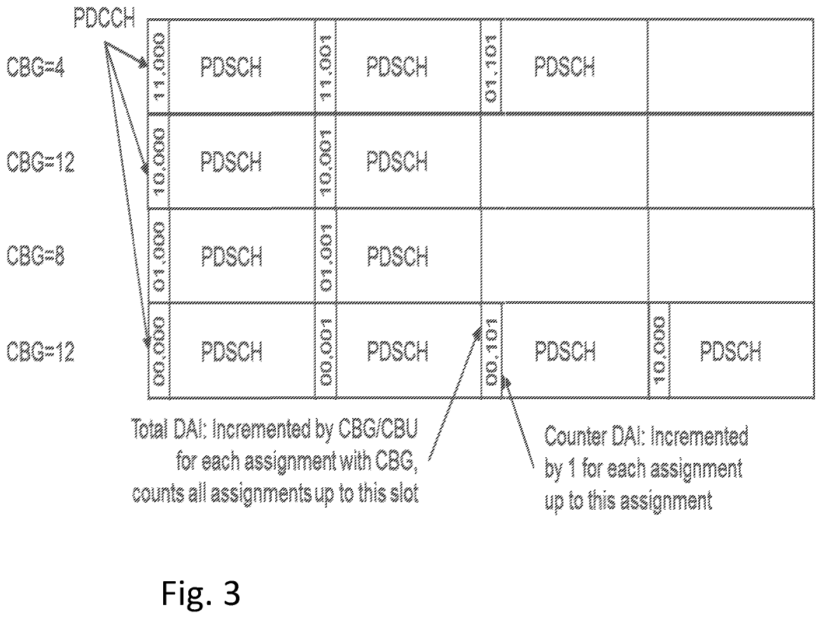

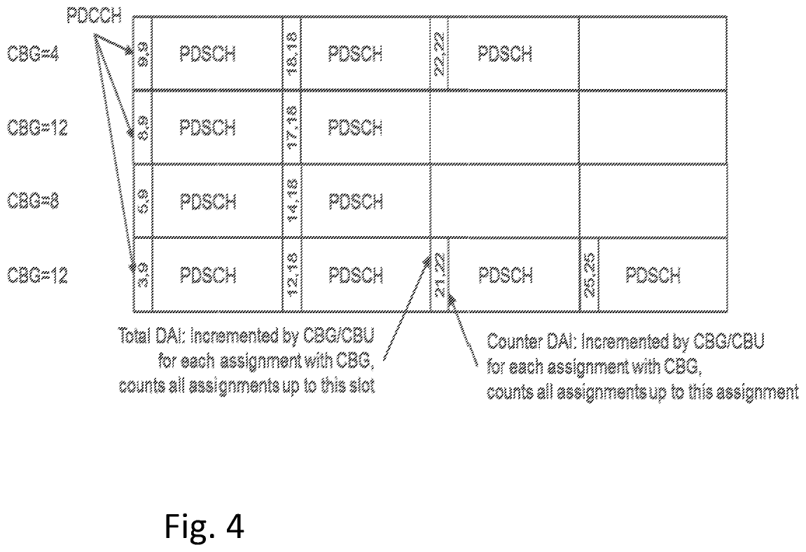

FIG. 3 and FIG. 4 show examples similar to those shown in FIGS. 1 and 2, but now also the counter DAI is increased in steps of the unit CBU. In FIG. 4, a bitfield size of 3 bit is assumed for both counter and total DAI.

In above examples, the DAIs (if they count size and not only assignments) indicate the end bit of the corresponding HARQ entry (counter DAI) or the end bit of the last HARQ entry in the slot (total DAI). Similar solutions can be designed where the start bit or a well defined bit within the HARQ entry is given by the DAIs, e.g. defined based on an offset between end bit and start bit.

The gain of incrementing DAI in CBU unit increases with the CBU size. It can therefore be beneficial to configure CBG across carriers to have a large CBU. This could imply altering original CBG configurations to a CBG configuration with larger CBU. For example, some configured maximum CBG per carriers can be forced to smaller or larger values. To obtain smaller configured maximum number of CBG on a carrier one can: 1) the maximum number of code block groups can be reduced on this carrier and/or 2) force bundling of HARQ bits of some code block groups may be considered, which changes the size of the bitmap that has to be included for a HARQ feedback. To increase the configured maximum number of CBG on a carrier, a larger number of code block groups may be configured, and/or padding (e.g., with a predefined value) the original HARQ feedback bitmap (subpattern) to the desired larger size may be considered. Artificially increasing a configured maximum number of CBG on a carrier trades DL overhead (the DAI size can be reduced with larger CBU) vs. UL overhead (the HARQ codebook and thus UCI increase with larger configured maximum number of CBG on a carrier).

If a component carrier is configured with MIMO, it may be preferable that the HARQ feedback size for this carrier is determined by the maximum number of HARQ feedback bits given the current MIMO configuration (rather than basing it on the current dynamic scheduling assignment) together with a CBG configuration.

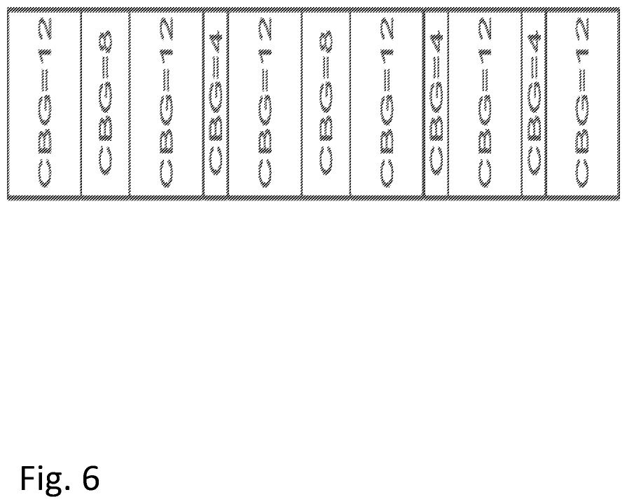

This method enables to have a dynamic (both in time and component carrier dimension) HARQ codebook where each entry has the size of configured maximum number of CBG on the scheduled carrier. FIG. 6 shows the HARQ codebook obtained with the scheduling pattern of FIG. 2. The order of HARQ entries (subpatterns) into the codebook needs to be specified. In this example, HARQ entries follow the counter DAI (i.e. feedback for earliest scheduled DL on first CC comes first), other ordering (e.g. in reverse order) can be envisioned as well. The codebook may generally be considered to represent or indicate an acknowledgement bit pattern.

This proposed scheme is not limited to HARQ but works for ARQ or other acknowledgement signaling as well.

Approaches to handle variable HARQ feedback size (subpattern size), e.g. due to different CBG configurations on different carriers, are disclosed. The approaches can be applied in general if the number of HARQ feedback messages and/or sizes (of the subpatterns) varies for other reasons. One example hereof is if the component carriers are configured with different DL/UL ratios (i.e. in a given amount of time different amounts of HARQ feedback need to be transmitted on the different component carriers depending on the number of DL transmissions in the reporting interval). Also, if PDSCH transmissions associated with HARQ codebook entries require different feedback sizes due to different MIMO configurations, the same principle can be applied.

In a carrier aggregation scenario with CBG configuration the configured maximum number of CBG across component carriers may be selected that they have a largest common divisor preferable larger than 1. The total DAI and optionally also counter DAI of the counter/total DAI mechanism may be counted in units of this largest common divisor, which reduces the value range and thus required field size of total DAI (and optionally of counter DAI if also applied to counter DAI).

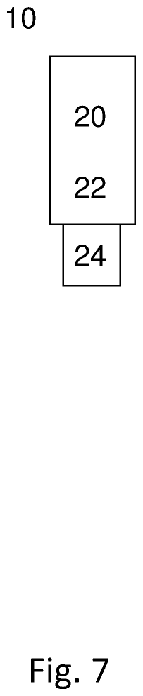

FIG. 7 schematically shows a radio node, in particular a terminal or wireless device 10, which may in particular be implemented as a UE (User Equipment). Radio node 10 comprises processing circuitry (which may also be referred to as control circuitry) 20, which may comprise a controller connected to a memory. Any module of the radio node 10, e.g. a communicating module or determining module, may be implemented in and/or executable by, the processing circuitry 20, in particular as module in the controller. Radio node 10 also comprises radio circuitry 22 providing receiving and transmitting or transceiving functionality (e.g., one or more transmitters and/or receivers and/or transceivers), the radio circuitry 22 being connected or connectable to the processing circuitry. An antenna circuitry 24 of the radio node 10 is connected or connectable to the radio circuitry 22 to collect or send and/or amplify signals. Radio circuitry 22 and the processing circuitry 20 controlling it are configured for cellular communication with a network, e.g. a RAN as described herein, and/or for sidelink communication. Radio node 10 may generally be adapted to carry out any of the methods of operating a radio node like terminal or UE disclosed herein; in particular, it may comprise corresponding circuitry, e.g. processing circuitry, and/or modules.

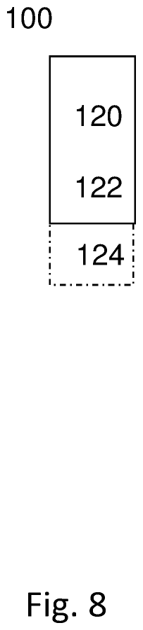

FIG. 8 schematically show a radio node 100, which may in particular be implemented as a network node 100, for example an eNB or gNB or similar for NR. Radio node 100 comprises processing circuitry (which may also be referred to as control circuitry) 120, which may comprise a controller connected to a memory. Any module, e.g. transmitting module and/or receiving module and/or configuring module of the node 100 may be implemented in and/or executable by the processing circuitry 120. The processing circuitry 120 is connected to control radio circuitry 122 of the node 100, which provides receiver and transmitter and/or transceiver functionality (e.g., comprising one or more transmitters and/or receivers and/or transceivers). An antenna circuitry 124 may be connected or connectable to radio circuitry 122 for signal reception or transmittance and/or amplification. Node 100 may be adapted to carry out any of the methods for operating a radio node or network node disclosed herein; in particular, it may comprise corresponding circuitry, e.g. processing circuitry, and/or modules. The antenna circuitry 124 may be connected to and/or comprise an antenna array. The node 100, respectively its circuitry, may be adapted to perform any of the methods of operating a network node or a radio node as described herein; in particular, it may comprise corresponding circuitry, e.g. processing circuitry, and/or modules. The radio node 100 may generally comprise communication circuitry, e.g. for communication with another network node, like a radio node, and/or with a core network and/or an internet or local net, in particular with an information system, which may provide information and/or data to be transmitted to a user equipment.

References to specific resource structures like transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), subframe, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4 symbols. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein.

A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A system comprising one or more radio nodes as described herein, in particular a network node and a user equipment, may be considered. The system may be a wireless communication system, and/or provide and/or represent a radio access network.

Moreover, there may be generally considered a method of operating an information system, the method comprising providing information. Alternatively, or additionally, an information system adapted for providing information may be considered. Providing information may comprise providing information for, and/or to, a target system, which may comprise and/or be implemented as radio access network and/or a radio node, in particular a network node or user equipment or terminal. Providing information may comprise transferring and/or streaming and/or sending and/or passing on the information, and/or offering the information for such and/or for download, and/or triggering such providing, e.g. by triggering a different system or node to stream and/or transfer and/or send and/or pass on the information. The information system may comprise, and/or be connected or connectable to, a target, for example via one or more intermediate systems, e.g. a core network and/or internet and/or private or local network. Information may be provided utilising and/or via such intermediate system/s. Providing information may be for radio transmission and/or for transmission via an air interface and/or utilising a RAN or radio node as described herein. Connecting the information system to a target, and/or providing information, may be based on a target indication, and/or adaptive to a target indication. A target indication may indicate the target, and/or one or more parameters of transmission pertaining to the target and/or the paths or connections over which the information is provided to the target. Such parameter/s may in particular pertain to the air interface and/or radio access network and/or radio node and/or network node. Example parameters may indicate for example type and/or nature of the target, and/or transmission capacity (e.g., data rate) and/or latency and/or reliability and/or cost, respectively one or more estimates thereof. The target indication may be provided by the target, or determined by the information system, e.g. based on information received from the target and/or historical information, and/or be provided by a user, for example a user operating the target or a device in communication with the target, e.g. via the RAN and/or air interface. For example, a user may indicate on a user equipment communicating with the information system that information is to be provided via a RAN, e.g. by selecting from a selection provided by the information system, for example on a user application or user interface, which may be a web interface. An information system may comprise one or more information nodes. An information node may generally comprise processing circuitry and/or communication circuitry. In particular, an information system and/or an information node may be implemented as a computer and/or a computer arrangement, e.g. a host computer or host computer arrangement and/or server or server arrangement. In some variants, an interaction server (e.g., web server) of the information system may provide a user interface, and based on user input may trigger transmitting and/or streaming information provision to the user (and/or the target) from another server, which may be connected or connectable to the interaction server and/or be part of the information system or be connected or connectable thereto. The information may be any kind of data, in particular data intended for a user of for use at a terminal, e.g. video data and/or audio data and/or location data and/or interactive data and/or game-related data and/or environmental data and/or technical data and/or traffic data and/or vehicular data and/or circumstantial data and/or operational data. The information provided by the information system may be mapped to, and/or mappable to, and/or be intended for mapping to, communication or data signaling and/or one or more data channels as described herein (which may be signaling or channel/s of an air interface and/or used within a RAN and/or for radio transmission). It may be considered that the information is formatted based on the target indication and/or target, e.g. regarding data amount and/or data rate and/or data structure and/or timing, which in particular may be pertaining to a mapping to communication or data signaling and/or a data channels. Mapping information to data signaling and/or data channel/s may be considered to refer to using the signaling/channel/s to carry the data, e.g. on higher layers of communication, with the signaling/channel/s underlying the transmission. A target indication generally may comprise different components, which may have different sources, and/or which may indicate different characteristics of the target and/or communication path/s thereto. A format of information may be specifically selected, e.g. from a set of different formats, for information to be transmitted on an air interface and/or by a RAN as described herein. This may be particularly pertinent since an air interface may be limited in terms of capacity and/or of predictability, and/or potentially be cost sensitive. The format may be selected to be adapted to the transmission indication, which may in particular indicate that a RAN or radio node as described herein is in the path (which may be the indicated and/or planned and/or expected path) of information between the target and the information system. A (communication) path of information may represent the interface/s (e.g., air and/or cable interfaces) and/or the intermediate system/s (if any), between the information system and/or the node providing or transferring the information, and the target, over which the information is, or is to be, passed on. A path may be (at least partly) undetermined when a target indication is provided, and/or the information is provided/transferred by the information system, e.g. if an internet is involved, which may comprise multiple, dynamically chosen paths. Information and/or a format used for information may be packet-based, and/or be mapped, and/or be mappable and/or be intended for mapping, to packets. Alternatively, or additionally, there may be considered a method for operating a target device comprising providing a target indicating to an information system. More alternatively, or additionally, a target device may be considered, the target device being adapted for providing a target indication to an information system. In another approach, there may be considered a target indication tool adapted for, and/or comprising an indication module for, providing a target indication to an information system. The target device may generally be a target as described above. A target indication tool may comprise, and/or be implemented as, software and/or application or app, and/or web interface or user interface, and/or may comprise one or more modules for implementing actions performed and/or controlled by the tool. The tool and/or target device may be adapted for, and/or the method may comprise, receiving a user input, based on which a target indicating may be determined and/or provided. Alternatively, or additionally, the tool and/or target device may be adapted for, and/or the method may comprise, receiving information and/or communication signaling carrying information, and/or operating on, and/or presenting (e.g., on a screen and/or as audio or as other form of indication), information. The information may be based on received information and/or communication signaling carrying information. Presenting information may comprise processing received information, e.g. decoding and/or transforming, in particular between different formats, and/or for hardware used for presenting. Operating on information may be independent of or without presenting, and/or proceed or succeed presenting, and/or may be without user interaction or even user reception, for example for automatic processes, or target devices without (e.g., regular) user interaction like MTC devices, of for automotive or transport or industrial use. The information or communication signaling may be expected and/or received based on the target indication. Presenting and/or operating on information may generally comprise one or more processing steps, in particular decoding and/or executing and/or interpreting and/or transforming information. Operating on information may generally comprise relaying and/or transmitting the information, e.g. on an air interface, which may include mapping the information onto signaling (such mapping may generally pertain to one or more layers, e.g. one or more layers of an air interface, e.g. RLC (Radio Link Control) layer and/or MAC layer and/or physical layer/s). The information may be imprinted (or mapped) on communication signaling based on the target indication, which may make it particularly suitable for use in a RAN (e.g., for a target device like a network node or in particular a UE or terminal). The tool may generally be adapted for use on a target device, like a UE or terminal. Generally, the tool may provide multiple functionalities, e.g. for providing and/or selecting the target indication, and/or presenting, e.g. video and/or audio, and/or operating on and/or storing received information. Providing a target indication may comprise transmitting or transferring the indication as signaling, and/or carried on signaling, in a RAN, for example if the target device is a UE, or the tool for a UE. It should be noted that such provided information may be transferred to the information system via one or more additionally communication interfaces and/or paths and/or connections. The target indication may be a higher-layer indication and/or the information provided by the information system may be higher-layer information, e.g. application layer or user-layer, in particular above radio layers like transport layer and physical layer. The target indication may be mapped on physical layer radio signaling, e.g. related to or on the user-plane, and/or the information may be mapped on physical layer radio communication signaling, e.g. related to or on the user-plane (in particular, in reverse communication directions). The described approaches allow a target indication to be provided, facilitating information to be provided in a specific format particularly suitable and/or adapted to efficiently use an air interface. A user input may for example represent a selection from a plurality of possible transmission modes or formats, and/or paths, e.g. in terms of data rate and/or packaging and/or size of information to be provided by the information system.

In general, a numerology and/or subcarrier spacing may indicate the bandwidth (in frequency domain) of a subcarrier of a carrier, and/or the number of subcarriers in a carrier and/or the numbering of the subcarriers in a carrier. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

Reference signaling may be signaling comprising one or more reference symbols and/or structures. Reference signaling may be adapted for gauging and/or estimating and/or representing transmission conditions, e.g. channel conditions and/or transmission path conditions and/or channel (or signal or transmission) quality. It may be considered that the transmission characteristics (e.g., signal strength and/or form and/or modulation and/or timing) of reference signaling are available for both transmitter and receiver of the signaling (e.g., due to being predefined and/or configured or configurable and/or being communicated). Different types of reference signaling may be considered, e.g. pertaining to uplink, downlink or sidelink, cell-specific (in particular, cell-wide, e.g., CRS) or device or user specific (addressed to a specific target or user equipment, e.g., CSI-RS), demodulation-related (e.g., DMRS) and/or signal strength related, e.g. power-related or energy-related or amplitude-related (e.g., SRS or pilot signaling) and/or phase-related, etc.

An antenna arrangement may comprise one or more antenna elements (radiating elements), which may be combined in antenna arrays. An antenna array or subarray may comprise one antenna element, or a plurality of antenna elements, which may be arranged e.g. two dimensionally (for example, a panel) or three dimensionally. It may be considered that each antenna array or subarray or element is separately controllable, respectively that different antenna arrays are controllable separately from each other. A single antenna element/radiator may be considered the smallest example of a subarray. Examples of antenna arrays comprise one or more multi-antenna panels or one or more individually controllable antenna elements. An antenna arrangement may comprise a plurality of antenna arrays. It may be considered that an antenna arrangement is associated to a (specific and/or single) radio node, e.g. a configuring or informing or scheduling radio node, e.g. to be controlled or controllable by the radio node. An antenna arrangements associated to a UE or terminal may be smaller (e.g., in size and/or number of antenna elements or arrays) than the antenna arrangement associated to a network node. Antenna elements of an antenna arrangement may be configurable for different arrays, e.g. to change the beam forming characteristics. In particular, antenna arrays may be formed by combining one or more independently or separately controllable antenna elements or subarrays. The beams may be provided by analog beamforming, or in some variants by digital beamforming. The informing radio nodes may be configured with the manner of beam transmission, e.g. by transmitting a corresponding indicator or indication, for example as beam identify indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (Analog-Digital-Converter, alternatively an ADC chain) to convert digital control information into an analog antenna feed for the whole antenna arrangement (the ADC may be considered part of, and/or connected or connectable to, antenna circuitry). A scenario in which each antenna element is individually controllable may be referred to as digital beamforming, whereas a scenario in which larger arrays/subarrays are separately controllable may be considered an example of analog beamforming. Hybrid forms may be considered.

Uplink or sidelink signaling may be OFDMA (Orthogonal Frequency Division Multiple Access) or SC-FDMA (Single Carrier Frequency Division Multiple Access) signaling. Downlink signaling may in particular be OFDMA signaling. However, signaling is not limited thereto (Filter-Bank based signaling may be considered one alternative).

A radio node may generally be considered a device or node adapted for wireless and/or radio (and/or microwave) frequency communication, and/or for communication utilising an air interface, e.g. according to a communication standard.

A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or transmission point (TP) and/or access point (AP) and/or other node, in particular for a RAN as described herein.

The terms wireless device, user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary.

A radio node may generally comprise processing circuitry and/or radio circuitry. A radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g. 2D or 3D array, and/or antenna panels. A remote radio head (RRH) may be considered as an example of an antenna array. However, in some variants, a RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air interface/s and/or cable interface/s and/or optical interface/s, e.g. laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g. controlled by communication circuitry and/or processing circuitry.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A radio access network may be a wireless communication network, and/or a Radio Access Network (RAN) in particular according to a communication standard. A communication standard may in particular a standard according to 3GPP and/or 5G, e.g. according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g. LTE Evolution and/or NR (New Radio), respectively successors thereof. A RAN may comprise one or more network nodes, and/or one or more terminals, and/or one or more radio nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal may be mobile, or in some cases stationary. A RAN or a wireless communication network may comprise at least one network node and a UE, or at least two radio nodes. There may be generally considered a wireless communication network or system, e.g. a RAN or RAN system, comprising at least one radio node, and/or at least one network node and at least one terminal.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Control information or a control information message or corresponding signaling (control signaling) may be transmitted on a control channel, e.g. a physical control channel, which may be a downlink channel or (or a sidelink channel in some cases, e.g. one UE scheduling another UE). For example, control information/allocation information may be signaled by a network node on PDCCH (Physical Downlink Control Channel) and/or a PDSCH (Physical Downlink Shared Channel) and/or a HARQ-specific channel. Acknowledgement signaling, e.g. as a form of control information or signaling like uplink control information/signaling, may be transmitted by a terminal on a PUCCH (Physical Uplink Control Channel) and/or PUSCH (Physical Uplink Shared Channel) and/or a HARQ-specific channel. Multiple channels may apply for multi-component/multi-carrier indication or signaling.

Signaling may generally be considered to represent an electromagnetic wave structure (e.g., over a time interval and frequency interval), which is intended to convey information to at least one specific or generic (e.g., anyone who might pick up the signaling) target. A process of signaling may comprise transmitting the signaling. Transmitting signaling, in particular control signaling or communication signaling, e.g. comprising or representing acknowledgement signaling and/or resource requesting information, may comprise encoding and/or modulating. Encoding and/or modulating may comprise error detection coding and/or forward error correction encoding and/or scrambling. Receiving control signaling may comprise corresponding decoding and/or demodulation. Error detection coding may comprise, and/or be based on, parity or checksum approaches, e.g. CRC (Cyclic Redundancy Check). Forward error correction coding may comprise and/or be based on for example turbo coding and/or Reed-Muller coding, and/or polar coding and/or LDPC coding (Low Density Parity Check). The type of coding used may be based on the channel (e.g., physical channel) the coded signal is associated to. A code rate may represent the ratio of the number of information bits before encoding to the number of encoded bits after encoding, considering that encoding adds coding bits for error detection coding and forward error correction.

Communication signaling may comprise, and/or represent, and/or be implemented as, data signaling, and/or user plane signaling. Communication signaling may be associated to a data channel, e.g. a physical downlink channel or physical uplink channel or physical sidelink channel, in particular a PDSCH (Physical Downlink Shared Channel) or PSSCH (Physical Sidelink Shared Channel). Generally, a data channel may be a shared channel or a dedicated channel. Data signaling may be signaling associated to and/or on a data channel.

An indication generally may explicitly and/or implicitly indicate the information it represents and/or indicates. Implicit indication may for example be based on position and/or resource used for transmission. Explicit indication may for example be based on a parametrisation with one or more parameters, and/or one or more index or indices, and/or one or more bit patterns representing the information. It may in particular be considered that control signaling as described herein, based on the utilised resource sequence, implicitly indicates the control signaling type.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g. as defined by a standard. A carrier may define a frequency and/or frequency band for transmission and/or reception. In some variants, a signal (jointly encoded/modulated) may cover more than one resource elements. A resource element may generally be as defined by a corresponding standard, e.g. NR or LTE. As symbol time length and/or subcarrier spacing (and/or numerology) may be different between different symbols and/or subcarriers, different resource elements may have different extension (length/width) in time and/or frequency domain, in particular resource elements pertaining to different carriers.

A resource generally may represent a time-frequency and/or code resource, on which signaling, e.g. according to a specific format, may be communicated, for example transmitted and/or received, and/or be intended for transmission and/or reception.

A border symbol may generally represent a starting symbol or an ending symbol for transmitting and/or receiving. A starting symbol may in particular be a starting symbol of uplink or sidelink signaling, for example control signaling or data signaling. Such signaling may be on a data channel or control channel, e.g. a physical channel, in particular a physical uplink shared channel (like PUSCH) or a sidelink data or shared channel, or a physical uplink control channel (like PUCCH) or a sidelink control channel. If the starting symbol is associated to control signaling (e.g., on a control channel), the control signaling may be in response to received signaling (in sidelink or downlink), e.g. representing acknowledgement signaling associated thereto, which may be HARQ or ARQ signaling. An ending symbol may represent an ending symbol (in time) of downlink or sidelink transmission or signaling, which may be intended or scheduled for the radio node or user equipment. Such downlink signaling may in particular be data signaling, e.g. on a physical downlink channel like a shared channel, e.g. a PDSCH (Physical Downlink Shared Channel). A starting symbol may be determined based on, and/or in relation to, such an ending symbol.

Configuring a radio node, in particular a terminal or user equipment, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources. A radio node may configure itself, e.g., based on configuration data received from a network or network node. A network node may utilise, and/or be adapted to utilise, its circuitry/ies for configuring. Allocation information may be considered a form of configuration data. Configuration data may comprise and/or be represented by configuration information, and/or one or more corresponding indications and/or message/s

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node.

Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor.

A resource structure may be considered to be neighbored in frequency domain by another resource structure, if they share a common border frequency, e.g. one as an upper frequency border and the other as a lower frequency border. Such a border may for example be represented by the upper end of a bandwidth assigned to a subcarrier n, which also represents the lower end of a bandwidth assigned to a subcarrier n+1. A resource structure may be considered to be neighbored in time domain by another resource structure, if they share a common border time, e.g. one as an upper (or right in the figures) border and the other as a lower (or left in the figures) border. Such a border may for example be represented by the end of the symbol time interval assigned to a symbol n, which also represents the beginning of a symbol time interval assigned to a symbol n+1.

Generally, a resource structure being neighbored by another resource structure in a domain may also be referred to as abutting and/or bordering the other resource structure in the domain.

A resource structure may general represent a structure in time and/or frequency domain, in particular representing a time interval and a frequency interval. A resource structure may comprise and/or be comprised of resource elements, and/or the time interval of a resource structure may comprise and/or be comprised of symbol time interval/s, and/or the frequency interval of a resource structure may comprise and/or be comprised of subcarrier/s. A resource element may be considered an example for a resource structure, a slot or mini-slot or a Physical Resource Block (PRB) or parts thereof may be considered others. A resource structure may be associated to a specific channel, e.g. a PUSCH or PUCCH, in particular resource structure smaller than a slot or PRB.

Examples of a resource structure in frequency domain comprise a bandwidth or band, or a bandwidth part. A bandwidth part may be a part of a bandwidth available for a radio node for communicating, e.g. due to circuitry and/or configuration and/or regulations and/or a standard. A bandwidth part may be configured or configurable to a radio node. In some variants, a bandwidth part may be the part of a bandwidth used for communicating, e.g. transmitting and/or receiving, by a radio node. The bandwidth part may be smaller than the bandwidth (which may be a device bandwidth defined by the circuitry/configuration of a device, and/or a system bandwidth, e.g. available for a RAN). It may be considered that a bandwidth part comprises one or more resource blocks or resource block groups, in particular one or more PRBs or PRB groups. A bandwidth part may pertain to, and/or comprise, one or more carriers.

A carrier may generally represent a frequency range or band and/or pertain to a central frequency and an associated frequency interval. It may be considered that a carrier comprises a plurality of subcarriers. A carrier may have assigned to it a central frequency or center frequency interval, e.g. represented by one or more subcarriers (to each subcarrier there may be generally assigned a frequency bandwidth or interval). Different carriers may be non-overlapping, and/or may be neighboring in frequency domain.

It should be noted that the term “radio” in this disclosure may be considered to pertain to wireless communication in general, and may also include wireless communication utilising microwave and/or millimeter and/or other frequencies, in particular between 100 MHz or 1 GHz, and 100 GHz or 20 or 10 GHz. Such communication may utilise one or more carriers.

A radio node, in particular a network node or a terminal, may generally be any device adapted for transmitting and/or receiving radio and/or wireless signals and/or data, in particular communication data, in particular on at least one carrier. The at least one carrier may comprise a carrier accessed based on a LBT procedure (which may be called LBT carrier), e.g., an unlicensed carrier. It may be considered that the carrier is part of a carrier aggregate.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for DL communication/transmission (called DL carrier). It may be considered that a cell comprises different numbers of UL carriers and DL carriers. Alternatively, or additionally, a cell may comprise at least one carrier for UL communication/transmission and DL communication/transmission, e.g., in TDD-based approaches.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have two component channels, one for each direction. Examples of channels comprise a channel for low latency and/or high reliability transmission, in particular a channel for Ultra-Reliable Low Latency Communication (URLLC), which may be for control and/or data.

In general, a symbol may represent and/or be associated to a symbol time length, which may be dependent on the carrier and/or subcarrier spacing and/or numerology of the associated carrier. Accordingly, a symbol may be considered to indicate a time interval having a symbol time length in relation to frequency domain. A symbol time length may be dependent on a carrier frequency and/or bandwidth and/or numerology and/or subcarrier spacing of, or associated to, a symbol. Accordingly, different symbols may have different symbol time lengths. In particular, numerologies with different subcarrier spacings may have different symbol time length. Generally, a symbol time length may be based on, and/or include, a guard time interval or cyclic extension, e.g. prefix or postfix.

A sidelink may generally represent a communication channel (or channel structure) between two UEs and/or terminals, in which data is transmitted between the participants (UEs and/or terminals) via the communication channel, e.g. directly and/or without being relayed via a network node. A sidelink may be established only and/or directly via air interface/s of the participant, which may be directly linked via the sidelink communication channel. In some variants, sidelink communication may be performed without interaction by a network node, e.g. on fixedly defined resources and/or on resources negotiated between the participants. Alternatively, or additionally, it may be considered that a network node provides some control functionality, e.g. by configuring resources, in particular one or more resource pool/s, for sidelink communication, and/or monitoring a sidelink, e.g. for charging purposes.

Sidelink communication may also be referred to as device-to-device (D2D) communication, and/or in some cases as ProSe (Proximity Services) communication, e.g. in the context of LTE. A sidelink may be implemented in the context of V2x communication (Vehicular communication), e.g. V2V (Vehicle-to-Vehicle), V2I (Vehicle-to-Infrastructure) and/or V2P (Vehicle-to-Person). Any device adapted for sidelink communication may be considered a user equipment or terminal.

A sidelink communication channel (or structure) may comprise one or more (e.g., physical or logical) channels, e.g. a PSCCH (Physical Sidelink Control CHannel, which may for example carry control information like an acknowledgement position indication, and/or a PSSCH (Physical Sidelink Shared CHannel, which for example may carry data and/or acknowledgement signaling). It may be considered that a sidelink communication channel (or structure) pertains to and/or used one or more carrier/s and/or frequency range/s associated to, and/or being used by, cellular communication, e.g. according to a specific license and/or standard. Participants may share a (physical) channel and/or resources, in particular in frequency domain and/or related to a frequency resource like a carrier) of a sidelink, such that two or more participants transmit thereon, e.g. simultaneously, and/or time-shifted, and/or there may be associated specific channels and/or resources to specific participants, so that for example only one participant transmits on a specific channel or on a specific resource or specific resources, e.g., in frequency domain and/or related to one or more carriers or subcarriers.

A sidelink may comply with, and/or be implemented according to, a specific standard, e.g. a LTE-based standard and/or NR. A sidelink may utilise TDD (Time Division Duplex) and/or FDD (Frequency Division Duplex) technology, e.g. as configured by a network node, and/or preconfigured and/or negotiated between the participants. A user equipment may be considered to be adapted for sidelink communication if it, and/or its radio circuitry and/or processing circuitry, is adapted for utilising a sidelink, e.g. on one or more frequency ranges and/or carriers and/or in one or more formats, in particular according to a specific standard. It may be generally considered that a Radio Access Network is defined by two participants of a sidelink communication. Alternatively, or additionally, a Radio Access Network may be represented, and/or defined with, and/or be related to a network node and/or communication with such a node.

Communication or communicating may generally comprise transmitting and/or receiving signaling. Communication on a sidelink (or sidelink signaling) may comprise utilising the sidelink for communication (respectively, for signaling). Sidelink transmission and/or transmitting on a sidelink may be considered to comprise transmission utilising the sidelink, e.g. associated resources and/or transmission formats and/or circuitry and/or the air interface. Sidelink reception and/or receiving on a sidelink may be considered to comprise reception utilising the sidelink, e.g. associated resources and/or transmission formats and/or circuitry and/or the air interface. Sidelink control information (e.g., SCI) may generally be considered to comprise control information transmitted utilising a sidelink.

Generally, carrier aggregation (CA) may refer to the concept of a radio connection and/or communication link between a wireless and/or cellular communication network and/or network node and a terminal or on a sidelink comprising a plurality of carriers for at least one direction of transmission (e.g. DL and/or UL), as well as to the aggregate of carriers. A corresponding communication link may be referred to as carrier aggregated communication link or CA communication link; carriers in a carrier aggregate may be referred to as component carriers (CC). In such a link, data may be transmitted over more than one of the carriers and/or all the carriers of the carrier aggregation (the aggregate of carriers). A carrier aggregation may comprise one (or more) dedicated control carriers and/or primary carriers (which may e.g. be referred to as primary component carrier or PCC), over which control information may be transmitted, wherein the control information may refer to the primary carrier and other carriers, which may be referred to as secondary carriers (or secondary component carrier, SCC). However, in some approaches, control information may be send over more than one carrier of an aggregate, e.g. one or more PCCs and one PCC and one or more SCCs.

A transmission may generally pertain to a specific channel and/or specific resources, in particular with a starting symbol and ending symbol in time, covering the interval therebetween. A scheduled transmission may be a transmission scheduled and/or expected and/or for which resources are scheduled or provided or reserved. However, not every scheduled transmission has to be realized. For example, a scheduled downlink transmission may not be received, or a scheduled uplink transmission may not be transmitted due to power limitations, or other influences (e.g., a channel on an unlicensed carrier being occupied). A transmission may be scheduled for a transmission timing substructure (e.g., a mini-slot, and/or covering only a part of a transmission timing structure) within a transmission timing structure like a slot. A border symbol may be indicative of a symbol in the transmission timing structure at which the transmission starts or ends.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

A configuration or schedule, like a mini-slot configuration and/or structure configuration, may schedule transmissions, e.g. for the time/transmissions it is valid, and/or transmissions may be scheduled by separate signaling or separate configuration, e.g. separate RRC signaling and/or downlink control information signaling. The transmission/s scheduled may represent signaling to be transmitted by the device for which it is scheduled, or signaling to be received by the device for which it is scheduled, depending on which side of a communication the device is. It should be noted that downlink control information or specifically DCI signaling may be considered physical layer signaling, in contrast to higher layer signaling like MAC (Medium Access Control) signaling or RRC layer signaling. The higher the layer of signaling is, the less frequent/the more time/resource consuming it may be considered, at least partially due to the information contained in such signaling having to be passed on through several layers, each layer requiring processing and handling.

A scheduled transmission, and/or transmission timing structure like a mini-slot or slot, may pertain to a specific channel, in particular a physical uplink shared channel, a physical uplink control channel, or a physical downlink shared channel, e.g. PUSCH, PUCCH or PDSCH, and/or may pertain to a specific cell and/or carrier aggregation. A corresponding configuration, e.g. scheduling configuration or symbol configuration may pertain to such channel, cell and/or carrier aggregation. It may be considered that the scheduled transmission represents transmission on a physical channel, in particular a shared physical channel, for example a physical uplink shared channel or physical downlink shared channel. For such channels, semi-persistent configuring may be particularly suitable.

Generally, a configuration may be a configuration indicating timing, and/or be represented or configured with corresponding configuration data. A configuration may be embedded in, and/or comprised in, a message or configuration or corresponding data, which may indicate and/or schedule resources, in particular semi-persistently and/or semi-statically.

A control region of a transmission timing structure may be an interval in time for intended or scheduled or reserved for control signaling, in particular downlink control signaling, and/or for a specific control channel, e.g. a physical downlink control channel like PDCCH. The interval may comprise, and/or consist of, a number of symbols in time, which may be configured or configurable, e.g. by (UE-specific) dedicated signaling (which may be single-cast, for example addressed to or intended for a specific UE), e.g. on a PDCCH, or RRC signaling, or on a multicast or broadcast channel. In general, the transmission timing structure may comprise a control region covering a configurable number of symbols. It may be considered that in general the border symbol is configured to be after the control region in time.

The duration of a symbol (symbol time length or interval) of the transmission timing structure may generally be dependent on a numerology and/or carrier, wherein the numerology and/or carrier may be configurable. The numerology may be the numerology to be used for the scheduled transmission.

Scheduling a device, or for a device, and/or related transmission or signaling, may be considered comprising, or being a form of, configuring the device with resources, and/or of indicating to the device resources, e.g. to use for communicating. Scheduling may in particular pertain to a transmission timing structure, or a substructure thereof (e.g., a slot or a mini-slot, which may be considered a substructure of a slot). It may be considered that a border symbol may be identified and/or determined in relation to the transmission timing structure even if for a substructure being scheduled, e.g. if an underlying timing grid is defined based on the transmission timing structure. Signaling indicating scheduling may comprise corresponding scheduling information and/or be considered to represent or contain configuration data indicating the scheduled transmission and/or comprising scheduling information. Such configuration data or signaling may be considered a resource configuration or scheduling configuration. It should be noted that such a configuration (in particular as single message) in some cases may not be complete without other configuration data, e.g. configured with other signaling, e.g. higher layer signaling. In particular, the symbol configuration may be provided in addition to scheduling/resource configuration to identify exactly which symbols are assigned to a scheduled transmission. A scheduling (or resource) configuration may indicate transmission timing structure/s and/or resource amount (e.g., in number of symbols or length in time) for a scheduled transmission.

A scheduled transmission may be transmission scheduled, e.g. by the network or network node. Transmission may in this context may be uplink (UL) or downlink (DL) or sidelink (SL) transmission. A device, e.g. a user equipment, for which the scheduled transmission is scheduled, may accordingly be scheduled to receive (e.g., in DL or SL), or to transmit (e.g. in UL or SL) the scheduled transmission. Scheduling transmission may in particular be considered to comprise configuring a scheduled device with resource/s for this transmission, and/or informing the device that the transmission is intended and/or scheduled for some resources. A transmission may be scheduled to cover a time interval, in particular a successive number of symbols, which may form a continuous interval in time between (and including) a starting symbol and an ending symbols. The starting symbol and the ending symbol of a (e.g., scheduled) transmission may be within the same transmission timing structure, e.g. the same slot. However, in some cases, the ending symbol may be in a later transmission timing structure than the starting symbol, in particular a structure following in time. To a scheduled transmission, a duration may be associated and/or indicated, e.g. in a number of symbols or associated time intervals. In some variants, there may be different transmissions scheduled in the same transmission timing structure. A scheduled transmission may be considered to be associated to a specific channel, e.g. a shared channel like PUSCH or PDSCH.

In the context of this disclosure, there may be distinguished between dynamically scheduled or aperiodic transmission and/or configuration, and semi-static or semi-persistent or periodic transmission and/or configuration. The term “dynamic” or similar terms may generally pertain to configuration/transmission valid and/or scheduled and/or configured for (relatively) short timescales and/or a (e.g., predefined and/or configured and/or limited and/or definite) number of occurrences and/or transmission timing structures, e.g. one or more transmission timing structures like slots or slot aggregations, and/or for one or more (e.g., specific number) of transmission/occurrences. Dynamic configuration may be based on low-level signaling, e.g. control signaling on the physical layer and/or MAC layer, in particular in the form of DCI or SCI. Periodic/semi-static may pertain to longer timescales, e.g. several slots and/or more than one frame, and/or a non-defined number of occurrences, e.g., until a dynamic configuration contradicts, or until a new periodic configuration arrives. A periodic or semi-static configuration may be based on, and/or be configured with, higher-layer signaling, in particular RCL layer signaling and/or RRC signaling and/or MAC signaling.

A transmission timing structure may comprise a plurality of symbols, and/or define an interval comprising several symbols (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signaling is received, e.g. in relation to the timing grid. A transmission timing structure may in particular be a slot or subframe or in some cases, a mini-slot.

Feedback signaling may be considered a form or control signaling, e.g. uplink or sidelink control signaling, like UCI (Uplink Control Information) signaling or SCI (Sidelink Control Information) signaling. Feedback signaling may in particular comprise and/or represent acknowledgement signaling and/or acknowledgement information and/or measurement reporting.

Acknowledgement information may comprise an indication of a specific value or state for an acknowledgement signaling process, e.g. ACK or NACK or DTX. Such an indication may for example represent a bit or bit value or bit pattern or an information switch. Different levels of acknowledgement information, e.g. providing differentiated information about quality of reception and/or error position in received data element/s may be considered and/or represented by control signaling. Acknowledgment information may generally indicate acknowledgment or non-acknowledgment or non-reception or different levels thereof, e.g. representing ACK or NACK or DTX. Acknowledgment information may pertain to one acknowledgement signaling process. Acknowledgement signaling may comprise acknowledgement information pertaining to one or more acknowledgement signaling processes, in particular one or more HARQ or ARQ processes. It may be considered that to each acknowledgment signaling process the acknowledgement information pertains to, a specific number of bits of the information size of the control signaling is assigned. Measurement reporting signaling may comprise measurement information.

Signaling may generally comprise one or more symbols and/or signals and/or messages. A signal may comprise and/or represent one or more bits, which may be modulated into a common modulated signal. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different acknowledgement signaling processes, e.g. representing and/or pertaining to one or more such processes. An indication may comprise signaling and/or a plurality of signals and/or messages and/or may be comprised therein, which may be transmitted on different carriers and/or be associated to different acknowledgement signaling processes, e.g. representing and/or pertaining to one or more such processes.

Signaling utilising, and/or on and/or associated to, resources or a resource structure may be signaling covering the resources or structure, signaling on the associated frequency/ies and/or in the associated time interval/s. It may be considered that a signaling resource structure comprises and/or encompasses one or more substructures, which may be associated to one or more different channels and/or types of signaling and/or comprise one or more holes (resource element/s not scheduled for transmissions or reception of transmissions). A resource substructure, e.g. a feedback resource structure, may generally be continuous in time and/or frequency, within the associated intervals. It may be considered that a substructure, in particular a feedback resource structure, represents a rectangle filled with one or more resource elements in time/frequency space. However, in some cases, a resource structure or substructure, in particular a frequency resource range, may represent a non-continuous pattern of resources in one or more domains, e.g. time and/or frequency. The resource elements of a substructure may be scheduled for associated signaling.

It should generally be noted that the number of bits or a bit rate associated to specific signaling that can be carried on a resource element may be based on a modulation and coding scheme (MCS). Thus, bits or a bit rate may be seen as a form of resources representing a resource structure or range in frequency and/or time, e.g. depending on MCS. The MCS may be configured or configurable, e.g. by control signaling, e.g. DCI or MAC (Medium Access Control) or RRC (Radio Resource Control) signaling.

Different formats of for control information may be considered, e.g. different formats for a control channel like a Physical Uplink Control Channel (PUCCH). PUCCH may carry control information or corresponding control signaling, e.g. Uplink Control Information (UCI). UCI may comprise feedback signaling, and/or acknowledgement signaling like HARQ feedback (ACK/NACK), and/or measurement information signaling, e.g. comprising Channel Quality Information (CQ), and/or Scheduling Request (SR) signaling. One of the supported PUCCH formats may be short, and may e.g. occur at the end of a slot interval, and/or multiplexed and/or neighboring to PUSCH. Similar control information may be provided on a sidelink, e.g. as Sidelink Control Information (SCI), in particular on a (physical) sidelink control channel, like a (P)SCCH.

A code block may be considered a subelement of a data element like a transport block, e.g., a transport block may comprise a one or a plurality of code blocks.

A scheduling assignment may be configured with control signaling, e.g. downlink control signaling or sidelink control signaling. Such controls signaling may be considered to represent and/or comprise scheduling signaling, which may indicate scheduling information. A scheduling assignment may be considered scheduling information indicating scheduling of signaling/transmission of signaling, in particular pertaining to signaling received or to be received by the device configured with the scheduling assignment. It may be considered that a scheduling assignment may indicate data (e.g., data block or element and/or channel and/or data stream) and/or an (associated) acknowledgement signaling process and/or resource/s on which the data (or, in some cases, reference signaling) is to be received and/or indicate resource/s for associated feedback signaling, and/or a feedback resource range on which associated feedback signaling is to be transmitted. Transmission associated to an acknowledgement signaling process, and/or the associated resources or resource structure, may be configured and/or scheduled, for example by a scheduling assignment. Different scheduling assignments may be associated to different acknowledgement signaling processes. A scheduling assignment may be considered an example of downlink control information or signaling, e.g. if transmitted by a network node and/or provided on downlink (or sidelink control information if transmitted using a sidelink and/or by a user equipment).

A scheduling grant (e.g., uplink grant) may represent control signaling (e.g., downlink control information/signaling). It may be considered that a scheduling grant configures the signaling resource range and/or resources for uplink (or sidelink) signaling, in particular uplink control signaling and/or feedback signaling, e.g. acknowledgement signaling. Configuring the signaling resource range and/or resources may comprise configuring or scheduling it for transmission by the configured radio node. A scheduling grant may indicate a channel and/or possible channels to be used/usable for the feedback signaling, in particular whether a shared channel like a PUSCH may be used/is to be used. A scheduling grant may generally indicate uplink resource/s and/or an uplink channel and/or a format for control information pertaining to associated scheduling assignments. Both grant and assignment/s may be considered (downlink or sidelink) control information, and/or be associated to, and/or transmitted with, different messages.

A resource structure in frequency domain (which may be referred to as frequency interval and/or range) may be represented by a subcarrier grouping. A subcarrier grouping may comprise one or more subcarriers, each of which may represent a specific frequency interval, and/or bandwidth. The bandwidth of a subcarrier, the length of the interval in frequency domain, may be determined by the subcarrier spacing and/or numerology. The subcarriers may be arranged such that each subcarrier neighbours at least one other subcarrier of the grouping in frequency space (for grouping sizes larger than 1). The subcarriers of a grouping may be associated to the same carrier, e.g. configurably or configured of predefined. A physical resource block may be considered representative of a grouping (in frequency domain). A subcarrier grouping may be considered to be associated to a specific channel and/or type of signaling, it transmission for such channel or signaling is scheduled and/or transmitted and/or intended and/or configured for at least one, or a plurality, or all subcarriers in the grouping. Such association may be time-dependent, e.g. configured or configurable or predefined, and/or dynamic or semi-static. The association may be different for different devices, e.g. configured or configurable or predefined, and/or dynamic or semi-static. Patterns of subcarrier groupings may be considered, which may comprise one or more subcarrier groupings (which may be associated to same or different signalings/channels), and/or one or more groupings without associated signaling (e.g., as seen from a specific device). An example of a pattern is a comb, for which between pairs of groupings associated to the same signaling/channel there are arranged one or more groupings associated to one or more different channels and/or signaling types, and/or one or more groupings without associated channel/signaling).

Example types of signaling comprise signaling of a specific communication direction, in particular, uplink signaling, downlink signaling, sidelink signaling, as well as reference signaling (e.g., SRS or CRS or CSI-RS), communication signaling, control signaling, and/or signaling associated to a specific channel like PUSCH, PDSCH, PUCCH, PDCCH, PSCCH, PSSCH, etc.).

In this disclosure, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM). While described variants may pertain to certain Technical Specifications (TSs) of the Third Generation Partnership Project (3GPP), it will be appreciated that the present approaches, concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

### Some Useful Abbreviations Comprise

### Abbreviation Explanation

ACK/NACK Acknowledgment/Negative Acknowledgement
ARQ Automatic Repeat reQuest
CAZAC Constant Amplitude Zero Cross Correlation
CBG Code Block Group
CDM Code Division Multiplex
CM Cubic Metric
CQI Channel Quality Information
CRC Cyclic Redundancy Check
CRS Common reference signal
CSI Channel State Information
CSI-RS Channel state information reference signal
DAI Downlink Assignment Indicator
DCI Downlink Control Information
DFT Discrete Fourier Transform
DM(-)RS Demodulation reference signal(ing)
FDM Frequency Division Multiplex
HARQ Hybrid Automatic Repeat Request
IFFT Inverse Fast Fourier Transform
MBB Mobile Broadband
MCS Modulation and Coding Scheme
MIMO Multiple-input-multiple-output
MRC Maximum-ratio combining
MRT Maximum-ratio transmission
MU-MIMO Multiuser multiple-input-multiple-output
OFDM/A Orthogonal Frequency Division Multiplex/Multiple Access
PAPR Peak to Average Power Ratio
PDCCH Physical Downlink Control Channel
PDSCH Physical Downlink Shared Channel
PRACH Physical Random Access CHannel
PRB Physical Resource Block
PUCCH Physical Uplink Control Channel
PUSCH Physical Uplink Shared Channel
(P)SCCH (Physical) Sidelink Control Channel
(P)SSCH (Physical) Sidelink Shared Channel
RB Resource Block
RRC Radio Resource Control
SC-FDM/A Single Carrier Frequency Division Multiplex/Multiple Access
SCI Sidelink Control Information
SINR Signal-to-interference-plus-noise ratio
SIR Signal-to-interference ratio
SNR Signal-to-noise-ratio
SR Scheduling Request
SRS Sounding Reference Signal(ing)
SVD Singular-value decomposition
TDM Time Division Multiplex
UCI Uplink Control Information
UE User Equipment
URLLC Ultra Low Latency High Reliability Communication
VL-MIMO Very-large multiple-input-multiple-output

Abbreviations may be considered to follow 3GPP usage if applicable.

1. A method of operating a user equipment in a radio access network, the method comprising transmitting acknowledgement signaling, the acknowledgement signaling representing acknowledgement information having an acknowledgement bit pattern;
the acknowledgement bit pattern comprising a plurality of subpatterns, each subpattern representing acknowledgment information pertaining to one of a plurality of data block structures, the bit pattern being determined based on a total assignment indication and at least one assignment indication;
each of the at least one assignment indication indicating a bit size of an associated subpattern; and
the total assignment indication indicating a bit size of the acknowledgement bit pattern.

2. A user equipment for a radio access network, the user equipment being configured to transmit acknowledgement signaling, the acknowledgement signaling representing acknowledgement information having an acknowledgement bit pattern;
the acknowledgement bit pattern comprising a plurality of subpatterns, each subpattern representing acknowledgment information pertaining to one of a plurality of data block structures, the bit pattern being determined based on a total assignment indication and at least one assignment indication;
each of the at least one assignment indication indicating a bit size of an associated subpattern; and
the total assignment indication indicating a bit size of the acknowledgement bit pattern.

3. A method of operating a radio node in a radio access network, the method comprising:
configuring a second radio node for transmitting acknowledgment signaling, the acknowledgement signaling representing acknowledgement information having an acknowledgement bit pattern;
the acknowledgement bit pattern comprising a plurality of subpatterns, each subpattern representing acknowledgment information pertaining to one of a plurality of data block structures; and
the configuring comprising transmitting, to the second radio node:
at least one assignment indication indicating a bit size of an associated subpattern;
and a total assignment indication indicating a bit size of the acknowledgement bit pattern.

4. A radio node for a radio access network, the radio node being configured to:
configure a second radio node to transmit acknowledgment signaling, the acknowledgement signaling representing acknowledgement information having an acknowledgement bit pattern;
the acknowledgement bit pattern comprising a plurality of subpatterns, each subpattern representing acknowledgment information pertaining to one of a plurality of data block structures; and
the configuring comprising transmitting, to the second radio node:
at least one assignment indication indicating a bit size of an associated subpattern;
and a total assignment indication indicating a bit size of the acknowledgement bit pattern.

5. The method according to claim 1, wherein the bit sizes of the associated subpatterns are configurable to be different between at least two subpatterns.

6. The method according to claim 1, wherein the bit size of at least one of the associated subpatterns is larger than one.

7. The method according to claim 1, wherein the bit sizes of a plurality of subpatterns have a common largest divisor larger than 1.

8. The method according to claim 1, wherein the plurality of data block structures comprises at least one of:
at least one transport block;
at least one code block; and
at least one code block group.

9. The method according to claim 1, wherein the assignment indication for a subpattern is included in a control information message scheduling the data block structure to which the subpattern pertains.

10. The method according to claim 1, wherein the total assignment indication is included in a control information message, the control information message also including an assignment indication for a subpattern.

11. The method according to claim 1, wherein the total assignment indication and an assignment indication for a subpattern are included in a control information message also scheduling the data block structure to which the subpattern pertains.

12. The method according to claim 1, wherein assignment indications represent accumulated sums of bit sizes of subpatterns.

13. The method according to claim 1, wherein an assignment indication indicates the bit size in units representing an integer number of bits larger than 1.

14. A computer storage medium storing executable program instructions that, when executed, cause processing circuitry to at least one of control and perform a method of operating a user equipment in a radio access network, the method comprising:
transmitting acknowledgement signaling, the acknowledgement signaling representing acknowledgement information having an acknowledgement bit pattern;
the acknowledgement bit pattern comprising a plurality of subpatterns, each subpattern representing acknowledgment information pertaining to one of a plurality of data block structures, the bit pattern being determined based on a total assignment indication and at least one assignment indication;
each of the at least one assignment indication indicating a bit size of an associated subpattern; and
the total assignment indication indicating a bit size of the acknowledgement bit pattern.

15. (canceled)

16. The method according to claim 3, wherein the bit sizes of the associated subpatterns are configurable to be different between at least two subpatterns.

17. The method according to claim 3, wherein the bit size of at least one of the associated subpatterns is larger than one.

18. The method according to claim 3, wherein the bit sizes of a plurality of subpatterns have a common largest divisor larger than 1.

19. The method according to claim 3, wherein the plurality of data block structures comprises at least one of:
at least one transport block;
at least one code block; and
at least one code block group.

20. The method according to claim 3, wherein the assignment indication for a subpattern is included in a control information message scheduling the data block structure to which the subpattern pertains.

21. The method according to claim 3, wherein the total assignment indication is included in a control information message, the control information message also including an assignment indication for a subpattern.
